(19) United States
(12) Patent Application Publication
(10) Pub. No.: US 2013/0001041 A1
(43) Pub. Date: Jan. 3, 2013

(54) BANKNOTE HANDLING APPARATUS AND COIN HANDLING APPARATUS

(76) Inventors: Kazuhiro DOI, Himeji-shi (JP); Minoru Higashiyama, Himeji-shi (JP); Keiju Nakagawa, Tatsuno-Shi (JP)

(21) Appl. No.: 13/535,426

(22) Filed: Jun. 28, 2012

(30) Foreign Application Priority Data
Jun. 29, 2011 (JP) 2011-144565

(51) Int. Cl. G07F 7/04; G07D 1/06

(52) U.S. Cl. 194/206; 453/1

(57) ABSTRACT

A banknote handling apparatus 20 configured to handle a banknote includes a control unit 70. The control unit 70 is configured to output information relating a coin change fund, when a banknote change fund is made in the banknote handling apparatus 20.

### CROSS REFERENCE TO RELATED APPLICATIONS

This application is based upon and claims the benefit of priority from the prior Japanese Patent Application No. 2011-144565 filed on Jun. 29, 2011, the entire contents of which are incorporated herein by reference.

### FIELD OF THE INVENTION

The present invention relates to a banknote handling apparatus configured to handle a banknote, and a coin handling apparatus configured to handle a coin.

### BACKGROUND ART

Various types of apparatuses have been known as a cash management apparatus installed in a retail business store such as a department store, a super market and a convenience store. For example, JP4385668B discloses a cash management apparatus configured to manage sales proceeds and so on stored in a cash register installed in a sales room of a store. Such a cash management apparatus is operated by a clerk such as an accounting staff of the store and an operator of the cash register. The cash management apparatus dispenses a cash such as a change fund to be stored as a change in the cash register, and deposits a cash such as sales proceeds collected from the cash register. In the cash management apparatus disclosed in JP4385668B, when a change fund is dispensed, an ID card of a clerk is verified, and then a change fund composed of a banknote and a coin is made by selecting one of dispensing patterns of a change fund (specifically, a pattern of the number of banknotes and coins by denomination), or by inputting the number of banknotes and coins to be dispensed by denomination, through a display unit or the like of a touch panel type.

### SUMMARY OF THE INVENTION

The cash management apparatus disclosed in JP4385668B is provided with a banknote handling unit configured to dispense a banknote change fund, and a coin handling unit configured to dispense a coin change fund, respectively. However, when both the banknote handling unit and the coin handling unit are provided on the cash management apparatus, the cost of the apparatus increases. Thus, there is a store in which only a banknote depositing/dispensing apparatus is provided as a cash management apparatus for making a change fund, the banknote depositing/dispensing apparatus being configured to perform a depositing operation and a dispensing operation of a banknote of a higher value, and a coin change fund is manually managed. However, in such a store, a breakdown of a coin change fund should be manually managed, which is inefficient in operation.

The present invention has been made in view of these circumstances. The object of the present invention is to provide a banknote handling apparatus capable of improving operation efficiency by outputting information relating to a coin change fund when a banknote change fund is made in the banknote handling apparatus, so that the banknote handling apparatus can partially support an operator when the operator manually makes the coin change fund.

In addition, the object of the present invention is to provide a coin handling apparatus capable of improving operation efficiency by outputting information relating to a banknote change fund when a coin change fund is made in the coin handling apparatus, so that the coin handling apparatus can partially support an operator when the operator manually makes the banknote change fund.

The present invention is a banknote handling apparatus that handles a banknote and includes a control unit configured to output information relating to a coin change fund, when a banknote change fund is made in the banknote handling apparatus.

According to the banknote handling apparatus of the present invention, when a banknote change fund is made in the banknote handling apparatus, the control unit is configured to output information relating to a coin change fund (e.g., a dispense pattern of the coin change fund, a total sum of the coin change fund and/or the number of coins by denomination). Thus, installation of a coin handling apparatus such as a coin depositing/dispensing apparatus in a backyard area or the like of a store system can be omitted, whereby a cost can be reduced. In addition, when a coin change fund is manually made without installing a coin depositing/dispensing apparatus, information relating to the coin change fund is outputted by the banknote depositing/dispensing apparatus. Thus, when an operator manually makes a coin change fund, the operator can confirm the outputted information. Namely, the banknote depositing/dispensing apparatus can partially support the operator so as to improve operation efficiency.

The banknote handling apparatus of the present invention may further include a display unit configured to display the information relating to the coin change fund outputted from the control unit.

Alternatively, the banknote handling apparatus of the present invention may further include a printing unit configured to print the information relating to the coin change fund outputted from the control unit.

Alternatively, the banknote handling apparatus of the present invention may further include an interface configured to transmit the information relating to the coin change fund outputted from the control unit to an apparatus separated from the banknote handling apparatus.

In the banknote handling apparatus of the present invention, the banknote handling apparatus may be connected, for communication, with a higher-level apparatus disposed separately from the banknote handling apparatus, and setting information of a change fund is transmitted from the higher-level apparatus to the banknote handling apparatus, and the control unit of the banknote handling apparatus may be configured to output the information relating to the coin change fund, based on the setting information of the change fund transmitted from the higher-level apparatus.

Alternatively, the banknote handling apparatus of the present invention may further include a memory unit configured to record the setting information of a change fund, and the control unit of the banknote handling apparatus may be configured to output the information relating to the coin change fund, based on the setting information of the change fund recorded in the memory unit.

Alternatively, the banknote handling apparatus of the present invention may further include a cassette reception unit configured to receive a cassette for storing a banknote, the cassette may be provided with a cassette memory unit and the cassette memory unit is configured to record the setting information of a change fund, and the control unit of the banknote handling apparatus may be configured to output the information relating to the coin change fund, based on the setting information of the change fund recorded in the cassette memory unit, when the cassette is received in the cassette reception unit.

At this time, the cassette memory unit may be configured to further record amount-of-money data of a cash settlement apparatus disposed independently from the banknote handling apparatus, and the control unit of the banknote handling apparatus may be configured to output the information relating to the coin change fund, in consideration of the amount-of-money data of the cash settlement apparatus recorded in the cassette memory unit, when the cassette is received in the cassette reception unit.

In addition, the cassette memory unit may be configured to further record storing information of a banknote stored in the cassette, and the control unit of the banknote handling apparatus may be configured to output the information relating to the coin change fund, in consideration of the storing information of a banknote recorded in the cassette memory unit, when the cassette is received in the cassette reception unit.

In addition, the banknote handling apparatus of the present invention may further include a writing unit configured to write information into the cassette memory unit of the cassette received in the cassette reception unit, and the writing unit may be configured to write the information relating to the coin change fund outputted from the control unit, into the cassette memory unit of the cassette received in the cassette reception unit.

In the banknote handling apparatus of the present invention, the banknote handling apparatus may be connected, for communication, with a cash settlement apparatus disposed independently from the banknote handling apparatus, and amount-of-money data of the cash settlement apparatus is transmitted from the cash settlement apparatus to the banknote handling apparatus, and the control unit of the banknote handling apparatus may be configured to output the information relating to the coin change fund, in consideration of the amount-of-money data of the cash settlement apparatus transmitted from the cash settlement apparatus.

In the banknote handling apparatus of the present invention, in a case where a banknote change fund falls short in making a banknote change fund in the banknote handling apparatus, when the information relating to the coin change fund is outputted, the control unit may add the number of coins by denomination whose sum corresponds to a sum of deficit banknote change fund, to the information relating to the coin change fund.

The present invention is a coin handling apparatus that handles a coin and includes a control unit configured to output information relating to a banknote change fund, when a coin change fund is made in the coin handling apparatus.

According to the coin handling apparatus of the present invention, when a coin change fund is made in the coin handling apparatus, the control unit is configured to output information relating to a banknote change fund (e.g., a dispense pattern of the banknote change fund, a total sum of the banknote change fund and/or the number of banknotes by denomination). Thus, installation of a banknote handling apparatus such as a banknote depositing/dispensing apparatus in a backyard area or the like of a store system can be omitted, whereby a cost can be reduced. In addition, when a banknote change fund is manually made without installing a banknote depositing/dispensing apparatus, information relating to the banknote change fund is outputted by the coin depositing/dispensing apparatus. Thus, when an operator manually makes a banknote change fund, the operator can confirm the outputted information. Namely, the coin depositing/dispensing apparatus can partially support the operator so as to improve operation efficiency.

As described above, according to the banknote handling apparatus of the present invention, when a banknote change fund is made, information relating to a coin change fund is outputted. Thus, when an operator manually makes the coin change fund, the banknote handling apparatus can partially support the operator so as to improve operation efficiency.

In a similar manner, according to the coin handling apparatus of the present invention, when a coin change fund is made, information relating to banknote change fund is outputted. Thus, when an operator manually makes a banknote change fund, the coin handling apparatus can partially support the operator so as to improve operation efficiency.

### BRIEF DESCRIPTION OF THE DRAWINGS

FIG. 1 is a structural view showing a structure of a store system in which a banknote depositing/dispensing apparatus according to an embodiment of the present invention is installed.

FIG. 2 is a schematic functional block view of the store system shown in FIG. 1.

FIG. 3 is a perspective view showing an appearance of the banknote depositing/dispensing apparatus in the store system shown in FIG. 1.

FIG. 4(a) is a structural view showing an internal structure of the banknote depositing/dispensing apparatus shown in FIG. 3, in which a banknote reception unit is mounted on a depositing unit.

FIG. 4(b) is a structural view showing the internal structure of the banknote depositing/dispensing apparatus shown in FIG. 3, in which a cash transport cassette is mounted on the depositing unit.

FIG. 5 is a functional block view of the banknote depositing/dispensing apparatus shown in FIG. 3.

FIG. 6 is a structural view showing a structure of a store system according to a modification example of the present invention.

FIG. 7 is a schematic functional block view of the store system shown in FIG. 6.

### DETAILED DESCRIPTION OF THE INVENTION

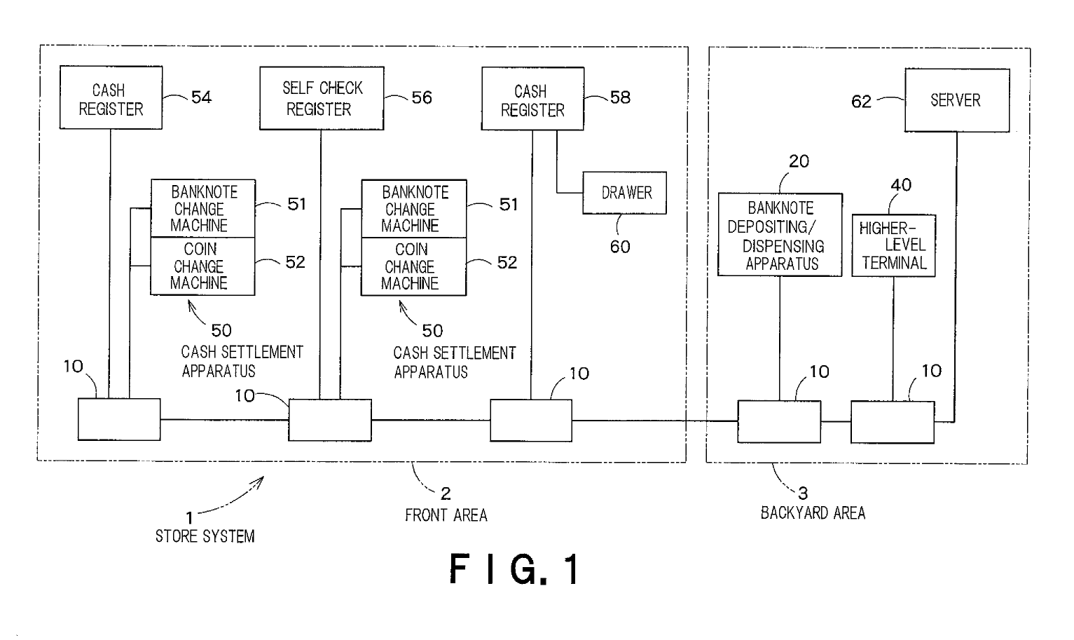

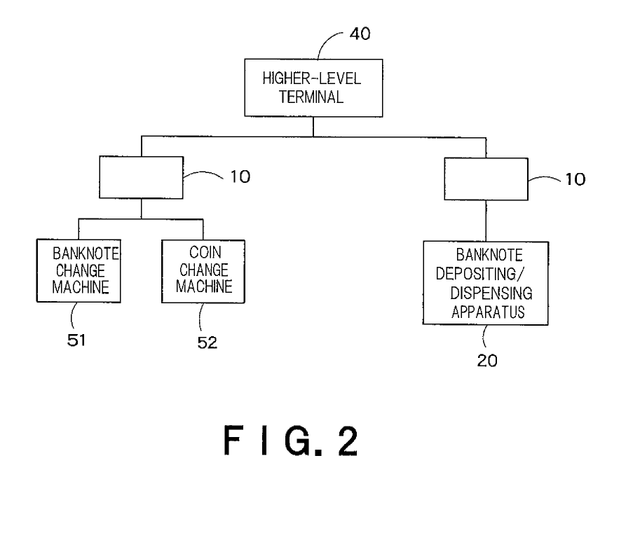

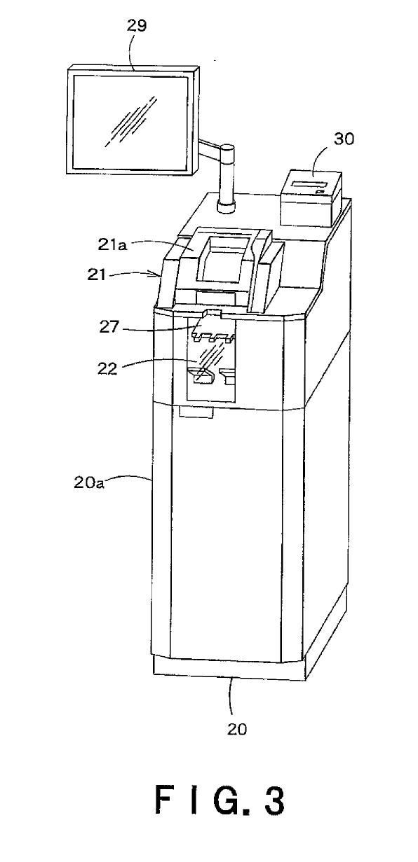

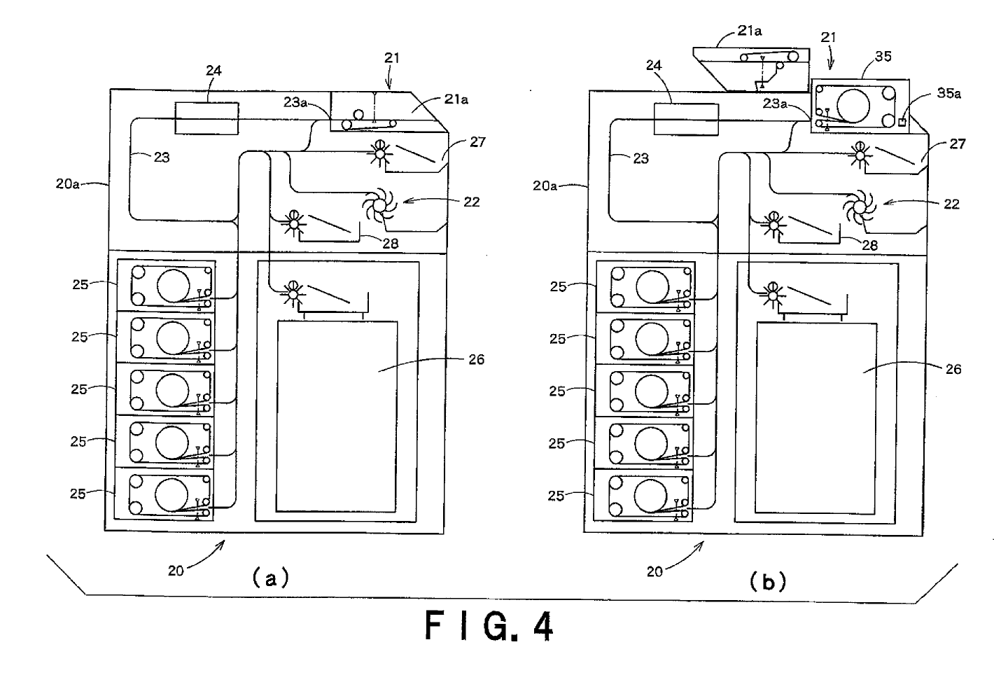

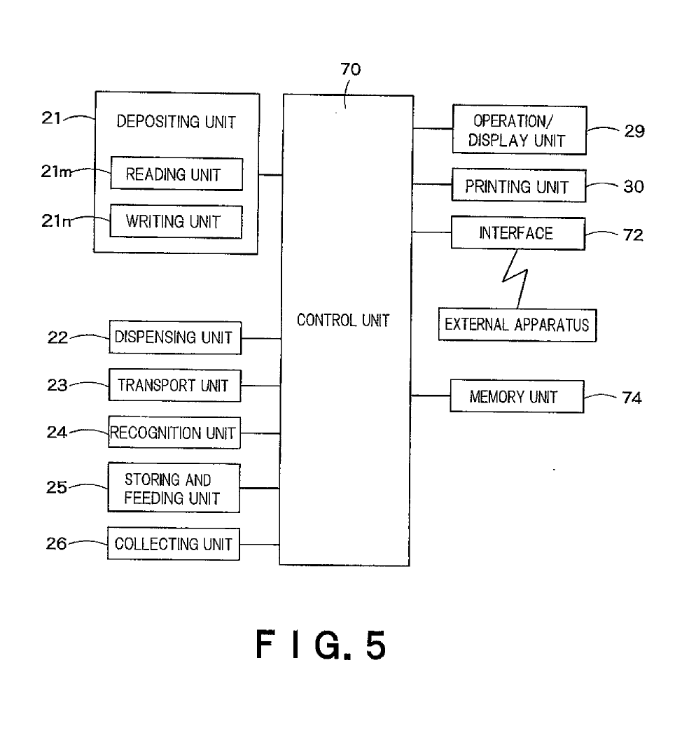

An embodiment of the present invention will be described herebelow with reference to the drawings. FIGS. 1 to 5 are views showing a banknote depositing/dispensing apparatus (banknote handling apparatus) according to this embodiment and a store system including the banknote depositing/dispensing apparatus. FIG. 1 is a structural view showing a structure of the store system in which the banknote depositing/dispensing apparatus according to this embodiment is installed. FIG. 2 is a schematic functional block view of the store system shown in FIG. 1. FIG. 3 is a perspective view showing an appearance of the banknote depositing/dispensing apparatus in the store system shown in FIG. 1. FIG. 4 is a structural view showing an internal structure of the banknote depositing/dispensing apparatus shown in FIG. 3. FIG. 5 is a functional block view of the banknote depositing/dispensing apparatus shown in FIG. 3.

A store system in which a banknote depositing/dispensing apparatus according to this embodiment is firstly described with reference to FIGS. 1 and 2. As shown in FIG. 1, the store system 1 is divided into a front area 2 in which a cash actually given and taken between a clerk and a customer is deposited and dispensed, and a backyard area 3 in which a cash and a commodity of the front area 2 are managed. In the front area 2, one or more cash settlement apparatus/apparatuses 50 including a banknote change machine 51 and a coin change machine 52 is/are installed. Each cash settlement apparatus 50 is operated by a clerk, and a settlement operation between a clerk and a customer is performed by the cash settlement apparatus 50. For example, each cash settlement apparatus 50 is configured to deposit money paid by a customer and to dispense a change to be paid to the customer. When each cash settlement apparatus 50 is of a type that is operated by a customer, the customer directly deposits money and receives a change therefrom. In the front area 2, a cash register 54 and a self check register 56 are disposed in the vicinity of each cash settlement apparatus 50. Each cash settlement apparatus 50 is connected, for communication, with a corresponding communication connection unit 10. The cash register 54 and the self check register 56 are also connected, for communication, with the communication connection unit 10 with which the corresponding cash settlement apparatus 50 is connected for communication. There is a case in which, instead of the cash register 54 that is disposed in the vicinity of the cash settlement apparatus 50, a cash register 58 is disposed in the vicinity of a drawer 60 by which a banknote and a coin are manually managed by a clerk, and the cash register 58 is connected, for communication, with the communication connection unit 10. In this case, the drawer 60 is connected, for communication, with the cash register 58. Each communication connection unit 10 disposed in the front area 2 is connected, for communication, with the below-described higher-level terminal 40 disposed in the backyard area 3. As the cash registers 54 and 58, a POS register, an ECR register or the like is used.

As shown in FIG. 1, in the backyard area 3, there are installed a banknote depositing/dispensing apparatus 20 and the higher-level terminal 40, respectively. The banknote depositing/dispensing apparatus 20 is configured to dispense a banknote (change fund) as a change to be loaded into the banknote change machine 51 of the cash settlement apparatus 50 installed in the front area 2, and to deposit a banknote collected from the banknote change machine 51. A coin depositing/dispensing machine for performing a coin depositing operation and a coin dispensing operation is not installed in the backyard area 3. The banknote depositing/dispensing apparatus 20 is connected, for communication, with the communication connection unit 10. The communication connection unit 10 is connected, for communication, with the higher-level terminal 40. In addition, a server 62 is installed in the backyard area 3. The server 62 is also connected, for communication, with the higher-level terminal 40 through the communication connection unit 10.

In the store system 1, there is used the below-described cash transport cassette 35 (not shown in FIGS. 1 and 2) which can be detachably mounted on the banknote change machine 51 of the cash settlement apparatus 50 and the banknote depositing/dispensing apparatus 20, respectively. A cash (banknote) is transferred between the banknote change machine 51 and the banknote depositing/dispensing apparatus 20 by means of such a cash transport cassette 35. When the cash transport cassette 35 is removed from the banknote change machine 51 and the banknote depositing/dispensing apparatus 20, a cash (banknote) stored in this banknote transport cassette 35 cannot be taken out therefrom.

As shown in FIG. 2, the higher-level terminal 40 is configured to transmit and receive various information to and from the banknote depositing/dispensing apparatus 20 disposed in the backyard area 3, through the communication connection unit 10. In addition, the higher-level terminal 40 is configured to transmit and receive various information to and from the banknote change machine 51 and the coin change machine 52 disposed in the front area 2, through the communication connection unit 10. Thus, when information is transmitted between the banknote change machine 51 or the coin change machine 52 and the banknote depositing/dispensing apparatus 20, the information to be transmitted passes through the higher-level terminal 40. Detailed contents of information to be transmitted between the higher-level terminal 40 and the banknote depositing/dispensing apparatus 20, and detailed contents of information to be transmitted between the higher-level terminal 40 and the banknote change machine 51 or the coin change machine 52 will be described below.

Next, a schematic structure of the banknote depositing/dispensing apparatus 20 is described with reference to FIGS. 3 to 5. FIG. 4 is a structural view showing an internal structure of the banknote depositing/dispensing apparatus 20 shown in FIG. 3, in which FIG. 4(a) is a view showing that a banknote reception unit 21a is mounted on a depositing unit 21, and FIG. 4(b) is a view showing that the cash transport cassette 35 is mounted on the depositing unit 21.

As shown in FIG. 4(a), the banknote depositing/dispensing apparatus 20 includes: a housing 20a, the depositing unit 21, a dispensing unit 22, an operation/display unit 29 (not shown in FIG. 4) and a printing unit 30 (not shown in FIG. 4). The banknote reception unit 21a is detachably mounted on the depositing unit 21. The banknote reception unit 21a is configured to receive a banknote from outside the banknote depositing/dispensing apparatus 20 and to feed the banknote, one by one, into the housing 20a, when the banknote reception unit 21a is mounted on the depositing unit 21. Such a banknote reception unit 21a is used when a clerk manually deposits a banknote into the banknote depositing/dispensing apparatus 20. As shown in FIG. 4(b), in place of the banknote reception unit 21a, the cash transport cassette 35 can be mounted on the depositing unit 21. When the cash transport cassette 35 is mounted on the depositing unit 21, a banknote in the cash transport cassette 35 is fed, one by one, into the housing 20a, by a feeding mechanism disposed inside the cash transport cassette 35.

In addition, as shown in FIG. 4(b), the cash transport cassette 35 is equipped with a cassette memory unit 35a. The cassette memory unit 35a is configured to record various information. As shown in FIG. 5, the depositing unit 21 includes a reading unit 21m and a writing unit 21n. The reading unit 21m is configured to read information recorded in the cassette memory unit 35a of the cash transport cassette 35, when the cash transport cassette 35 is mounted on the depositing unit 21. The writing unit 21n is configured to write information into the cassette memory unit 35a of the cash transport cassette 35, when the cash transport cassette 35 is mounted on the depositing unit 21. These reading unit 21m and the writing unit 21n are connected to the below-described control unit 70, so that information read by the reading unit 21m is transmitted to the control unit 70, and that the writing unit 21n writes the information into the cassette memory unit 35a based on information transmitted from the control unit 70.

As shown in FIG. 4, a transport unit 23 configured to transport a banknote one by one is provided in the housing 20a of the banknote depositing/dispensing apparatus 20. The aforementioned depositing unit 21 is disposed on an end 23a of the transport unit 23. When the banknote reception unit 21a or the cash transport unit 35 is mounted on the depositing unit 21, a banknote fed out from the banknote reception unit 21a or the cash transport cassette 35 is transported by the transport unit 23 via the end 23a of the transport unit 23.

As shown in FIG. 4, the transport unit 23 is equipped with a recognition unit 24. Denomination, fitness, authenticity and so on of a banknote transported by the transport unit 23 are recognized by the recognition unit 24.

In addition, a plurality of storing and feeding units 25 are disposed in the housing 20a. Each of the storing and feeding units 25 is connected to the transport unit 23. The respective storing and feeding units 25 are configured to store banknotes by denomination. In more detail, based on a recognition result by the recognition unit 24, a banknote, which has been fed out from the depositing unit 21 to the transport unit 23, is transported by the transport unit 23 to the respective storing and feeding units 25 by denomination. Each storing and feeding unit 25 is configured to feed a banknote, which is stored in the storing and feeding unit 25, one by one, to the transport unit 23. The string and feeding unit 25 may be a storing and feeding unit of a tape reeling type which reels up a pair of tapes between which a banknote is sandwiched one by one, which is shown in FIG. 4, or may be a storing and feeding unit of a stacker type which stores banknotes in a stacked manner (not shown).

A collecting unit 26 is disposed in the housing 20a. The collecting unit 26 is used when a banknote stored in the storing and feeding unit 25 is collected. To be more specific, a banknote storing pouch (not shown) for storing a banknote is detachably provided in the collecting unit 26. Thus, a banknote, which has been sent from the storing and feeding unit 25 to the collecting unit 26 via the transport unit 23, is stored into the banknote storing pouch. A banknote whose denomination is not allocated to any of the storing and feeding units 25, and an overflow banknote, which cannot be stored because the storing and feeding unit 25 of the corresponding denomination is full, are stored into the banknote storing pouch of the collecting unit 26. By taking out the banknote storing pouch from the collecting unit 26, a banknote stored in the banknote storing pouch can be collected, together with the banknote storing pouch, from the banknote depositing/dispensing apparatus 20.

As shown in FIG. 4, the banknote depositing/dispensing apparatus 20 is equipped with an outside-apparatus reject unit 27 and an in-apparatus reject unit 28, respectively. A banknote, which has been recognized by the recognition unit 24 as not a normal banknote, among banknotes having been taken into the housing 20a by the depositing unit 21, is sent as a reject banknote from the transport unit 23 to the outside-apparatus reject unit 27. The reject banknote is dispensed outside the banknote depositing/dispensing apparatus 20 by the outside-apparatus reject unit 27. On other hand, a reject banknote, which cannot be dispensed outside the banknote depositing/dispensing apparatus 20, is sent to the in-apparatus reject unit 28, and the reject banknote is stored in the in-apparatus reject unit 28. An operator such as a clerk who does not have a management authority cannot take out a banknote in the in-apparatus reject unit 28.

The operation/display unit 29 is configured to display various information such as a stored state of a banknote in the banknote depositing/dispensing apparatus 20. In addition, a clerk can input various instructions through the operation/display unit 29. The operation/display unit 29 is formed of, e.g., a display of a touch panel type. The printing unit 30 is formed of, e.g., a printer, and is configured to print various information onto a print sheet provided in the printing unit 30.

In the housing 20a of the banknote depositing/dispensing apparatus 20, there is disposed the control unit 70 configured to control the respective constituent elements of the banknote depositing/dispensing apparatus 20. A structure of the control unit 70 is described with reference to FIG. 5. As shown in FIG. 5, the control unit 70 is connected to the depositing unit 21, the dispensing unit 22, the transport unit 23, the recognition unit 24, the storing and feeding unit 25, the collecting unit 26, the operation/display unit 29, the printing unit 30 and so on, respectively. A banknote recognition result by the recognition unit 24 is transmitted to the control unit 70. By respectively transmitting instructions from the control unit 70 to the depositing unit 21, the dispensing unit 22, the transport unit 23, the storing and feeding unit 25, the collecting unit 26, and the printing unit 30, respectively, these constituent elements are controlled. In addition, information inputted by a clerk or the like through the operation/display unit 29 is transmitted to the control unit 70. The control unit 70 transmits information to the operation/display unit 29 so as to cause the operation/display unit 29 to display various information.

As shown in FIG. 5, an interface 72 is connected to the control unit 70. The control unit 70 can transmit and receive information to and from an external apparatus (specifically, the higher-level terminal 40) through the interface 72. In addition, a memory unit 74 is connected to the control unit 70. The memory unit 74 is configured to record various setting information of the banknote depositing/dispensing apparatus 20 and storing information such as the number of banknotes stored in the respective storing and feeding units 25 by denomination.

Next, an operation of the banknote depositing/dispensing apparatus 20 as structured above is described. The operation of the banknote depositing/dispensing apparatus 20 shown below is performed by the control unit 70 controlling the respective constituent elements of the banknote depositing/dispensing apparatus 20.

An operation for depositing a banknote to the banknote depositing/dispensing apparatus 20 is firstly described. Specifically, in the store system shown in FIG. 1 and so on, for example, a banknote as sales proceeds is collected from the banknote change machine 51 after the business hour of the store, and the collected banknote is deposited to the banknote depositing/dispensing apparatus 20. In the operation for depositing a banknote to the banknote depositing/dispensing apparatus 20, when a clerk manually deposits a banknote directly to the banknote depositing/dispensing apparatus 20, the banknote reception unit 21a is mounted on the depositing unit 21. Thus, the banknote reception unit 21a receives a banknote from outside the banknote depositing/dispensing apparatus 20 and feeds the banknote, one by one, into the housing 20a. On the other hand, when a banknote stored in the cash transport cassette 35 is deposited to the banknote depositing/dispensing apparatus 20, the cash transport cassette 35 is mounted on the depositing unit 21. In this case, when the cash transport cassette 35 is mounted on the depositing unit 21, a banknote in the cash transport cassette 35 is fed, one by one, into the housing 20a, by the feeding mechanism disposed inside the cash transport cassette 35.

The banknote, which has been fed out from the banknote reception unit 21a or the cash transport cassette 35 into the housing 20a, is transported by the transport unit 23, and is recognized by the recognition unit 24. A banknote, which has been recognized by the recognition unit 24 as a normal banknote, is stored into the storing and feeding unit 25 by denomination. On the other hand, when the storing and feeding unit 25 of the corresponding denomination is full or when the denomination of the banknote is not allocated to any of the storing and feeding units 25, a banknote is sent to the collecting unit 26, even though the banknote has been recognized by the recognition unit 24 as a normal banknote. Further, a banknote which has been recognized by the recognition unit 24 as not a normal banknote (e.g., a counterfeit banknote, a skewed banknote, overlapped banknotes and so on) or a banknote which could not be recognized by the recognition unit 24 is sent as a reject banknote to the outside-apparatus reject unit 27. In this manner, all the banknotes are fed out from the banknote reception unit 21a or the cash transport cassette 35 into the casing 20a and all the banknotes are stored into the respective storing and feeding units 25 and the collecting unit 26. Then, the banknote depositing operation in the banknote depositing/dispensing apparatus 20 is completed.

Next, an operation for dispensing a banknote from the banknote depositing/dispensing apparatus 20 is described. Specifically, in the store system 1 shown in FIG. 1 and so on, for example, when a banknote change fund is refilled to the banknote change machine 51 before the business hour of the store, a banknote change fund of a predetermined pattern is dispensed and made in the banknote depositing/dispensing apparatus 20. To be more specific, when a banknote change fund is made in the banknote depositing/dispensing apparatus 20, the cash transport cassette 35 is mounted on the depositing unit 21, and a banknote, which has been fed out from each storing and feeding unit 25, is stored into the cash transport cassette 35. When a banknote change fund is made in the banknote depositing/dispensing apparatus 20, the control unit 70 controls the respective constituent elements of the banknote depositing/dispensing apparatus 20 such that a banknote is fed out from each storing and feeding unit 25 based on a dispense pattern of a banknote change fund (specifically, a pattern showing the number of banknotes by denomination), and that the fed-out banknote is sent to the cash transport cassette 35 mounted on the depositing unit 21. Information relating to the dispense pattern of a change fund is previously stored in the memory unit 74 or transmitted from the higher-level terminal to the control unit 70 through the interface 72. Alternatively, a clerk may input information relating to the dispense pattern of a change fund to the control unit 70 through the operation/display unit 29. As further another method, the cassette memory unit 35a of the cash transport cassette 35 may record the dispense pattern of a change fund. In this case, when the cash transport cassette 35 is mounted on the depositing unit 21, the reading unit 21m reads the dispense pattern of a change fund recorded in the cassette memory unit 35a, and the read-out dispense pattern of a change fund is used.

In the banknote depositing/dispensing apparatus 20 in this embodiment, when a banknote change fund is made, the control unit 70 outputs information relating to a coin change fund. Specifically, the information relating to the coin change fund outputted from the control unit 70 is displayed on the operation/display unit 29 or printed by the printing unit 30. Thus, in the backyard area 3, a clerk can manually prepare the coin change fund, based on the information (information relating to the coin change fund) displayed on the operation/display unit 29 or printed by the printing unit 30. In addition, the information relating to the coin change fund outputted from the control unit 70 may be transmitted by the interface 72 to an apparatus separated from the banknote depositing/dispensing apparatus 20, specifically, the higher-level terminal 40 and/or the server 62, for example. In this case, the clerk can manually prepare the coin change fund, by checking information displayed on a display unit (not shown) of the higher-level terminal 40 or the server 62.

As described above, setting information of a change fund (e.g., a dispense pattern of a change fund) is transmitted from the higher-level terminal 40 to the banknote depositing/dispensing apparatus 20. Then, the control unit 70 of the banknote depositing/dispensing apparatus 20 outputs information relating to a coin change fund, based on the setting information of the change fund transmitted from the higher-level terminal 40. More specifically, the setting information of the change fund transmitted from the higher-level terminal 40 to the banknote depositing/dispensing apparatus 20 includes a dispense pattern of a coin change fund, in addition to a dispense pattern of a banknote change fund. Thus, as to the dispense pattern of a banknote change fund included in the setting information of the change fund transmitted from the higher-level terminal 40, the control unit 70 controls each storing and feeding unit 25 such that a banknote corresponding to the dispense pattern is fed out from each storing and feeding unit 25 and is stored into the cash transport cassette 35 mounted on the dispensing unit 21. On the other hand, as to the dispense pattern of a coin change fund, the control unit 70 outputs information relating to this dispense pattern so as to be displayed on the operation/display unit 29 or printed by the printing unit 30. As information relating to the coin change fund outputted from the control unit 70, a total sum of the coin change fund may be used instead of a dispense pattern of the coin change fund.

There is a case where the banknote depositing/dispensing apparatus 20 is not connected, for communication, with the higher-level terminal 40, but is of a standalone type (independent type). In this case, when a banknote change fund is dispensed and made in the banknote depositing/dispensing apparatus 20, the control unit 70 controls the respective constituent elements of the banknote depositing/dispensing apparatus 20 such that a banknote is fed out from each storing and feeding unit 25 based on setting information of a change fund (e.g., a dispense pattern of a change fund) recorded in the memory unit 74, and that the fed-out banknote is sent to the cash transport cassette 35 mounted on the depositing unit 21. In addition, there is a case where setting information of the change fund recorded in the memory unit 74 includes a dispense pattern of a coin change fund, in addition to a dispense pattern of a banknote change fund. In this case, when a banknote change fund is dispensed based on the setting information of the change fund recorded in the memory unit 74, the control unit 70 outputs information relating to the dispense pattern of a coin change fund included in the setting information of the change fund recorded in the memory unit 74 so as to be displayed on the operation/display unit 29 or printed by the printing unit 30.

In addition, there is a case where setting information of a change fund is recorded in the cassette memory unit 35a of the cash transport cassette 35. In this case, when the cash transport cassette 35 is mounted on the depositing unit 21, the reading unit 21m reads the setting information of the change fund recorded in the cassette memory unit 35a, and the read-out setting information of the change fund is used. At this time, there is a case where the setting information of the change fund recorded in the cassette memory unit 35a of the cash transport cassette 35 includes a dispense pattern of a coin change fund, in addition to a dispense pattern of a banknote change fund. In this case, when a banknote change fund is dispensed based on the setting information of the change fund read by the reading unit 21m, the control unit 70 outputs information relating to the dispense pattern of a coin change fund included in the setting information of the change fund read by the reading unit 21m so as to be displayed on the operation/display unit 29 or printed by the printing unit 30.

The cassette memory unit 35a may further record, in addition to the setting information of a change fund, amount-of-money information of the banknote change machine 51 and amount-of-money information of the coin change machine 52, specifically, the number of banknotes and coins by denomination stored in the banknote change machine 51 and the coin change machine 52. In addition, the cassette memory unit 35a may further record storing information of a banknote stored in the cash transport cassette 35, specifically, the number of banknotes stored in the cash transport cassette 35 by denomination. In this case, the control unit 70 outputs information relating to a coin change fund, in consideration of the amount-of-money information of the banknote change machine 51 and amount-of-money information of the coin change machine 52 recorded in the cassette memory unit 35a and the storing information of a banknote stored in the cash transport cassette 35, in addition to the setting information of the change fund recorded in the cassette memory unit 35a.

The writing unit 21n disposed on the depositing unit 21 may write information relating to a coin change fund outputted from the control unit 70 into the cassette memory unit 35a of the cash transport cassette 35, when the cash transport cassette 35 is mounted on the depositing unit 21. In this case, when the cash transport cassette 35 storing a banknote change fund is sent to the cash settlement apparatus 50 in the front area 2, the information relating to the coin change fund recorded in the cassette memory unit 35a of the cash transport cassette 35 is read out. Thus, a clerk can compare a coin change fund, which has been actually deposited manually to the coin change machine 52, with the information relating to coin change fund read out from the cassette memory unit 35a.

In the store system 1 in this embodiment, amount-of-money information of the banknote change machine and amount-of-money information of the coin change machine 52 may be transmitted from these banknote change machine 51 and the coin change machine 52 to the higher-level terminal 40, and the amount-of-money information, of the banknote change machine 51 and the amount-of-money information of the coin change machine 52 may be further transmitted from the higher-level terminal 40 to the banknote depositing/dispensing apparatus 20. In this case, the control unit 70 outputs information relating to a coin change fund, in consideration of the amount-of-money information of the banknote change machine 51 and the amount-of-money information of the coin change machine 52 transmitted from the higher-level terminal 40.

In addition, when a banknote change fund is dispensed and made in the banknote depositing/dispensing apparatus 20, there is a case where a banknote change fund actually stored in the banknote depositing/dispensing apparatus 20 falls short. In this case, when information relating to a coin change fund is outputted, the control unit 70 is configured to add the number of coins by denomination whose sum corresponds to a sum of deficit banknote change fund, to information relating to the coin change fund to be outputted. To be specific, when a banknote change fund actually stored in the banknote depositing/dispensing apparatus 20 falls short by 1000 yen, coins whose sum corresponds to 1000 yen, for example, ten 100-yen coins is added as a coin change fund to be outputted to the information relating to the coin change fund to be outputted.

As described above, according to the banknote depositing/dispensing apparatus 20 in this embodiment, when a banknote change fund is made in the banknote depositing/dispensing apparatus 20, the control unit 70 is configured to output information relating to a coin change fund (i.e., a dispense pattern of the coin change fund, a total sum of the coin change fund and/or the number of coins by denomination). Specifically, the information relating to the coin change fund outputted from the control unit 70 is displayed on the operation/display unit 29 or printed by the printing unit 30. In addition, there is a case where the information relating to the coin change fund outputted from the control unit 70 is transmitted by the interface 72 to an apparatus separated from the banknote depositing/dispensing apparatus 20. According to such a banknote depositing/dispensing apparatus 20, installation of a coin depositing/dispensing apparatus in the backyard area 3 of the store system 1 can be omitted, whereby a cost can be reduced. In addition, when a coin change fund is manually made without installing a coin depositing/dispensing apparatus, information relating to the coin change fund is outputted by the banknote depositing/dispensing apparatus 20. Thus, when an operator manually makes a coin change fund, the operator can confirm the information displayed on the operation/display unit 29 or printed by the printing unit 30. Namely, the banknote depositing/dispensing apparatus 20 can partially support the operator so as to improve operation efficiency.

In addition, in the banknote depositing/dispensing apparatus 20 in this embodiment, the banknote depositing/dispensing apparatus 20 is connected, for communication, with the higher-level terminal 40 separately disposed from the banknote depositing/dispensing apparatus 20, and setting information of a change fund is transmitted from the higher-level terminal 40 to the banknote depositing/dispensing apparatus 20. Thus, the control unit 70 is configured to output information relating to the coin change fund, based on the setting information of a change fund transmitted from the higher-level terminal 40. Alternatively, the control unit 70 of the banknote depositing/dispensing apparatus 20 may be configured to output information relating to the coin change fund, based on setting information of the change fund recorded in the memory unit 74. Alternatively, the control unit 70 of the banknote depositing/dispensing apparatus 20 may be configured to output information relating to the coin change fund, based on setting information of the change fund recorded in the cassette memory unit 35a of the cash transport cassette 35, when the cash transport cassette 35 is received in the depositing unit 21 (cassette reception unit).

In addition, in the banknote depositing/dispensing apparatus 20 in this embodiment, the cassette memory unit 35a can further record amount-of-money information of the banknote change machine 51 and amount-of-money information of the coin change machine 52. The control unit 70 of the banknote depositing/dispensing apparatus 20 is configured to output information relating to a coin change fund, in consideration of the amount-of-money information of the banknote change machine 51 and the amount-of-money information of the coin change machine 52 recorded in the cassette memory unit 35a, when the cash transport cassette 35 is received in the deposing unit 21 (cassette reception unit). To be specific, the number of coins by denomination and a total sum of the coins, which is a deduction of the amount-of-money information of the coin change machine 52 from the setting information of the coin change fund, are outputted as information relating to the coin change fund.

In addition, in the banknote depositing/dispensing apparatus 20 in this embodiment, the cassette memory unit 35a can further record storing information of a banknote stored in the cash transport cassette 35. The control unit 70 of the banknote depositing/dispensing apparatus 20 is configured to output information relating to a coin change fund, in consideration of the storing information of a banknote recorded in the cassette memory unit 35a, when the cash transport cassette 35 is received in the depositing unit 21 (cassette reception unit).

In addition, in the banknote depositing/dispensing apparatus 20 in this embodiment, there is provided the writing unit 21n that write information into the cassette memory unit 35a of the cash transport cassette 35 mounted on the depositing unit 21 (cassette reception unit). The writing unit 21n is configured to write information relating to a coin change fund outputted from the control unit 70 into the cassette memory unit 35a of the cash transport cassette 35. Thus, when the cash transport cassette 35 storing a banknote change fund is sent to the cash settlement apparatus 50 in the front area 2, the information relating to the coin change fund recorded in the cassette memory unit 35a of the cash transport cassette 35 is read out. Thus, a clerk can compare a coin change fund, which has been actually deposited manually to the coin change machine 52, with the information relating to the coin change fund read out from the cassette memory unit 35a.

In addition, in the banknote depositing/dispensing apparatus 20 in this embodiment, amount-of-money information of the banknote change machine 51 and amount-of-money information of the coin change machine 52 are transmitted from the banknote change machine 51 and the coin change machine 52 to the banknote depositing/dispensing apparatus 20 through the higher-level terminal 40. The control unit 70 of the banknote depositing/dispensing apparatus 20 is configured to output information relating to a coin change fund, in consideration of the amount-of-money information of the banknote change machine 51 and the amount-of-money information of the coin change machine 52. To be specific, the number of coins by denomination and a total sum of the coins, which is a deduction of the amount-of-money information of the coin change machine 52 from the setting information of the coin change fund, are outputted as information relating to the coin change fund. The amount-of-money information of the banknote change machine 51 and the amount-of-money information of the coin change machine 52 may not be transmitted from the banknote change machine 51 and the coin change machine 52 to the banknote depositing/dispensing apparatus 20 through the higher-level terminal 40, but the amount-of-money information of the banknote change machine 51 and the amount-of-money information of the coin change machine 52 may be transmitted from the banknote change machine 51 and the coin change machine 52 directly to the banknote depositing/dispensing apparatus 20. In addition, information relating to the coin change fund outputted from the control unit 70 of the banknote depositing/dispensing apparatus 20 may be transmitted to the banknote change machine 51 and the coin change machine 52 through the higher-level terminal 40 or directly. In this case, a clerk can compare a coin change fund, which has been actually deposited manually to the coin change machine 52, with the information relating to the coin change fund outputted from the control unit 70.

In addition, there is a case where, when a banknote change fund is made in the banknote depositing/dispensing apparatus 20, a banknote change fund falls short. In this case, the control unit 70 of the banknote depositing/dispensing apparatus 20 is configured to add the number of coins by denomination whose sum corresponds to a sum of deficit banknote change fund, to information relating to the coin change fund to be outputted.

The banknote depositing/dispensing apparatus 20 in this embodiment is not limited to the above embodiment, and can be variously modified. For example, a clerk may be informed of information relating to a coin change fund (a dispense pattern of the coin change fund, a total sum the coin change fund and/or number of coins by denomination) outputted from the control unit 70 by sound.

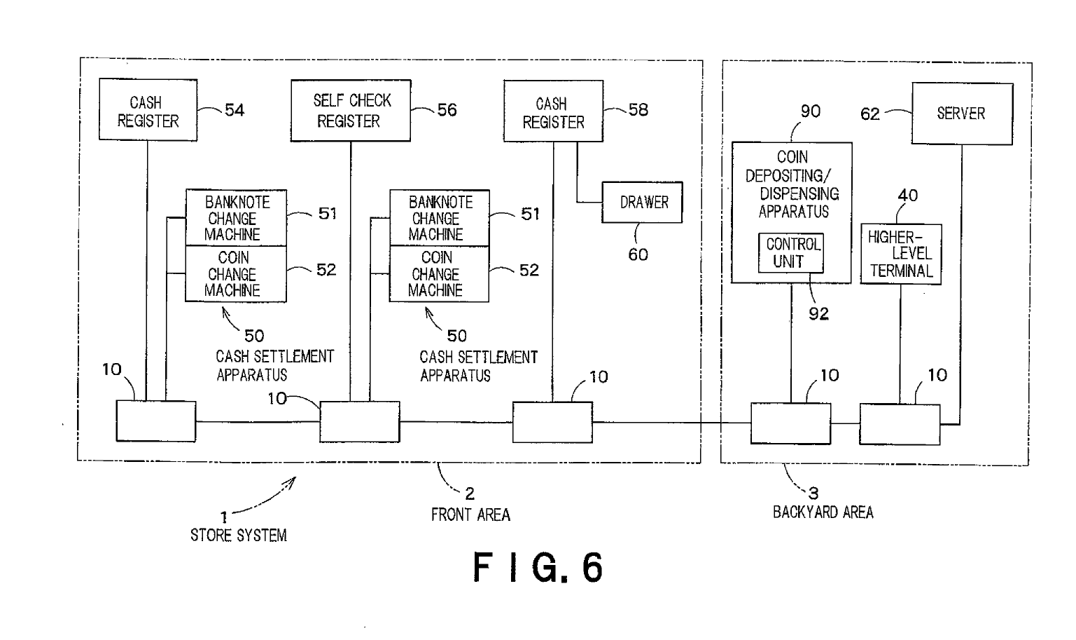

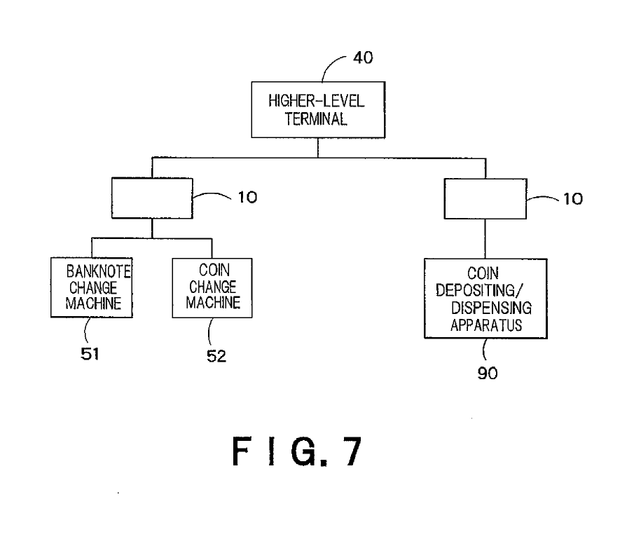

In addition, in the present invention, instead of installing the banknote depositing/dispensing apparatus 20 in the backyard area 3, a banknote depositing/dispensing apparatus may not be installed in the backyard area 3 but a coin depositing/dispensing apparatus may be installed in the backyard area 3. Such an aspect is described with reference to FIGS. 6 and 7.

As shown in FIG. 6, a coin depositing/dispensing apparatus 90 and a higher-level terminal 40 are respectively installed in a backyard area 3. The coin depositing/dispensing apparatus 90 is configured to dispense a coin (change fund) as a change to be loaded into a coin change machine 52 of a cash settlement apparatus 50 installed in a front area 2, and to deposit a coin collected from the coin change machine 52. In the embodiment shown in FIGS. 6 and 7, the backyard area 3 is not provided with a banknote depositing/dispensing apparatus for performing a banknote depositing operation and a banknote dispensing operation. The coin depositing/dispensing apparatus 90 is connected, for communication, with a communication connection unit 10. The communication connection unit 10 is connected, for communication, with the higher-level terminal 40. In addition, a server 62 is installed in the backyard area 3. The sever 62 is also connected, for communication, with the higher-level terminal 40 through the communication connection unit 10.

In a store system 1, there is used a cash transport cassette (not shown) that can be detachably mounted on the coin change machine 52 of the cash settlement apparatus 50 and the coin depositing/dispensing apparatus 90, respectively. A cash (coin) is transferred between the coin change machine 52 and the coin depositing/dispensing apparatus 90 by means of such a cash transport cassette.

As shown in FIG. 7, the higher-level terminal 40 is configured to transmit and receive various information to and from the coin depositing/dispensing apparatus 90 installed in the backyard 3 through the communication connection unit 10. In addition, the higher-level terminal 40 is configured to transmit and receive various information to and from the banknote change machine 51 and the coin change machine 52 installed in the front area 2 through the communication connection unit 10. Thus, when information is transmitted between the banknote change machine 51 or the coin change machine 52 and the coin depositing/dispensing apparatus 90, the information to be transmitted passes through the higher-level terminal 40.

In addition, in the embodiment shown in FIGS. 6 and 7, the coin depositing/dispensing apparatus 90 is equipped with a control unit 92 (see FIG. 6) configured to control the respective constituent elements of the coin depositing/dispensing apparatus 90. When a coin change fund is made in the coin depositing/dispensing apparatus 90, the control unit 92 is configured to output information relating to banknote change fund (e.g., a dispense pattern of a banknote change fund, a total sum of the banknote change fund and/or the number of banknotes by denomination). Specifically, the information relating to the banknote change fund outputted from the control unit 92 is displayed on an operation/display unit (not shown) provided on the coin depositing/dispensing apparatus 90 or printed by a printing unit (not shown) provided on the coin depositing/dispensing apparatus 90. In addition, there is a case where the information relating to the banknote change fund outputted from the control unit 92 is transmitted to an apparatus separated from the coin depositing/dispensing apparatus 90. According to such a coin depositing/dispensing apparatus 90, installation of a banknote depositing/dispensing apparatus in the backyard area 3 of the store system 1 can be omitted, whereby a cost can be reduced. In addition, when a banknote change fund is manually made without installing a banknote depositing/dispensing apparatus, information relating to the banknote change fund is outputted by the coin depositing/dispensing apparatus 90. Thus, when an operator manually makes a banknote change fund, the operator can confirm the information displayed on the operation/display unit or printed by the printing unit. Namely, the coin depositing/dispensing apparatus 90 can partially support the operator so as to improve operation efficiency.

1. A banknote handling apparatus that handles a banknote, comprising a control unit configured to output information relating to a coin change fund, when a banknote change fund is made in the banknote handling apparatus.

2. The banknote handling apparatus according to claim 1, further comprising a display unit configured to display the information relating to the coin change fund outputted from the control unit.

3. The banknote handling apparatus according to claim 1, further comprising a printing unit configured to print the information relating to the coin change fund outputted from the control unit.

4. The banknote handling apparatus according to claim 1, further comprising an interface configured to transmit the information relating to the coin change fund outputted from the control unit to an apparatus separated from the banknote handling apparatus.

5. The banknote handling apparatus according to claim 1, wherein
the banknote handling apparatus is connected, for communication, with a higher-level apparatus disposed separately from the banknote handling apparatus, and setting information of a change fund is transmitted from the higher-level apparatus to the banknote handling apparatus, and
the control unit of the banknote handling apparatus is configured to output the information relating to the coin change fund, based on the setting information of the change fund transmitted from the higher-level apparatus.

6. The banknote handling apparatus according to claim 1, further comprising a memory unit configured to record the setting information of a change fund, and
the control unit of the banknote handling apparatus is configured to output the information relating to the coin change fund, based on the setting information of the change fund recorded in the memory unit.

7. The banknote handling apparatus according to claim 1, further comprising a cassette reception unit configured to receive a cassette for storing a banknote, wherein
the cassette is provided with a cassette memory unit and the cassette memory unit is configured to record the setting information of a change fund, and
the control unit of the banknote handling apparatus is configured to output the information relating to the coin change fund, based on the setting information of the change fund recorded in the cassette memory unit, when the cassette is received in the cassette reception unit.

8. The banknote handling apparatus according to claim 7, wherein
the cassette memory unit is configured to further record amount-of-money data of a cash settlement apparatus disposed independently from the banknote handling apparatus, and
the control unit of the banknote handling apparatus is configured to output the information relating to the coin change fund, in consideration of the amount-of-money data of the cash settlement apparatus recorded in the cassette memory unit, when the cassette is received in the cassette reception unit.

9. The banknote handling apparatus according to claim 7, wherein
the cassette memory unit is configured to further record storing information of a banknote stored in the cassette, and
the control unit of the banknote handling apparatus is configured to output the information relating to the coin change fund, in consideration of the storing information of a banknote recorded in the cassette memory unit, when the cassette is received in the cassette reception unit.

10. The banknote handling apparatus according to claim 7, further comprising a writing unit configured to write information into the cassette memory unit of the cassette received in the cassette reception unit,
wherein the writing unit is configured to write the information relating to the coin change fund outputted from the control unit, into the cassette memory unit of the cassette received in the cassette reception unit.

11. The banknote handling apparatus according to claim 5, wherein
the banknote handling apparatus is connected, for communication, with a cash settlement apparatus disposed independently from the banknote handling apparatus, and amount-of-money data of the cash settlement apparatus is transmitted from the cash settlement apparatus to the banknote handling apparatus, and
the control unit of the banknote handling apparatus is configured to output the information relating to the coin change fund, in consideration of the amount-of-money data of the cash settlement apparatus transmitted from the cash settlement apparatus.

12. The banknote handling apparatus according to claim 6, wherein
the banknote handling apparatus is connected, for communication, with a cash settlement apparatus disposed independently from the banknote handling apparatus, and amount-of-money data of the cash settlement apparatus is transmitted from the cash settlement apparatus to the banknote handling apparatus, and
the control unit of the banknote handling apparatus is configured to output the information relating to the coin change fund, in consideration of the amount-of-money data of the cash settlement apparatus transmitted from the cash settlement apparatus.

13. The banknote handling apparatus according to claim 7, wherein
the banknote handling apparatus is connected, for communication, with a cash settlement apparatus disposed independently from the banknote handling apparatus, and amount-of-money data of the cash settlement apparatus is transmitted from the cash settlement apparatus to the banknote handling apparatus, and
the control unit of the banknote handling apparatus is configured to output the information relating to the coin change fund, in consideration of the amount-of-money data of the cash settlement apparatus transmitted from the cash settlement apparatus.

14. The banknote handling apparatus according to claim 1, wherein
in a case where a banknote change fund falls short in making a banknote change fund in the banknote handling apparatus, when the information relating to the coin change fund is outputted, the control unit is configured to add the number of coins by denomination whose sum corresponds to a sum of deficit banknote change fund, to the information relating to the coin change fund.

15. A coin handling apparatus that handles a coin, comprising a control unit configured to output information relating to a banknote change fund, when a coin change fund is made in the coin handling apparatus.
